(19) United States
(12) Patent Application Publication
(10) Pub. No.: US 2025/0305477 A1
(43) Pub. Date: Oct. 2, 2025

(54) PASSIVE TRAILING EDGE INCLUDING COMPOSITE HINGE

(71) Applicant: Gulf Wind technology, Avondale, LA (US)

(72) Inventor: Peter Anthony BROOME, Park Ridge, IL (US)

(73) Assignee: Gulf Wind Technology, Avondale, LA (US)

(21) Appl. No.: 19/097,467

(22) Filed: Apr. 1, 2025

Related U.S. Application Data
(60) Provisional application No. 63/573,146, filed on Apr. 2, 2024.

(51) Int. Cl. F03D 1/06

(52) U.S. Cl. CPC F03D 1/069; F05B 2240/304; F05B 2280/6003

(57) ABSTRACT

A multi-layer composite body that includes a first composite layer having a first elasticity parameter and a second composite layer mechanically coupled with the first composite layer. The second composite layer may have a second elasticity parameter that is different from the first elasticity parameter of the first composite layer. The first composite layer may include at least two transverse parts joined by a flexible folding zone such that the at least two transverse parts and the folding zone form a reversibly foldable and substantially two-dimensional homogenous structure. Further, the first composite layer and the second composite layer may respond to a common external mechanical force in a different manner.

### CROSS-REFERENCE TO RELATED APPLICATIONS

This non-provisional patent application claims priority to U.S. provisional patent application No. 63/573,146, filed on Apr. 2, 2024, titled “Passive trailing edge including composite hinge”, the contents of which are incorporated herein by reference in their entirety and should be considered part of this specification.

### BACKGROUND

Wind power is considered one of the cleanest, most environmentally friendly energy sources presently available, and wind turbines have gained increased attention in this regard. As the demand for wind energy continues to grow, there is an increasing emphasis on improving the efficiency of wind energy conversion systems. Wind turbine blades play a crucial role in capturing and converting wind energy into electrical power. Conventional designs, however, are often constrained by the trade-offs between aerodynamic efficiency and structural integrity. Specifically, traditional wind turbine blades face a number of challenges associated with aerodynamic drag, noise generation, and fatigue, which can limit their overall efficiency. In addition, these blades may be slow in their response to severe and unpredictable gust loads causing structural stress and increased fatigue degradation. There remains a need to optimize aerodynamic performance and passive load shedding while protecting and reducing structural stress on wind turbine blades.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is an illustrative view of a multi-layer composite structure, in accordance with an embodiment of this disclosure.

FIG. 2 is an illustrative view of a multi-layer composite structure, in accordance with an embodiment of this disclosure.

FIG. 3A is an illustrative side view of the composite structure of FIG. 1 or FIG. 2, in accordance with an embodiment of this disclosure.

FIG. 3B is an illustrative perspective view of the composite structure of FIG. 1 or FIG. 2, in accordance with an embodiment of this disclosure.

FIG. 4A is an illustrative view of the composite structure of FIG. 1 or FIG. 2 in the absence of external load condition.

FIG. 4B is an illustrative view of the composite structure of FIG. 1 or FIG. 2 under external load condition.

FIG. 4C is an illustrative view of the composite structure of FIG. 1 or FIG. 2 in the absence of external load condition.

FIG. 4D is an illustrative view of the composite structure of FIG. 1 or FIG. 2 under external load condition.

FIG. 4E is an illustrative view of the composite structure of FIG. 1 or FIG. 2 in the absence of external load condition.

FIG. 4F is an illustrative view of the composite structure of FIG. 1 or FIG. 2 under external load condition.

FIG. 5A is an illustrative view of the composite structure of FIG. 1 or FIG. 2 in the absence of external load condition.

FIG. 5B is an illustrative view of the composite structure of FIG. 1 or FIG. 2 under external load condition.

FIG. 5C is an illustrative view of the composite structure of FIG. 1 or FIG. 2 under increased external load condition.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The present disclosure relates to systems and methods of constructing passive trailing edge assemblies with predictable buckling responses under mechanical forces associated with extreme weather conditions. The systems and methods described herein may be designed to enhance the performance and efficiency of wind turbines and further, to optimize aerodynamic performance and passive load shedding while protecting and reducing structural stress. Specifically, various implementations of the disclosed subject matter relate generally to and may provide improvements in trailing edge assemblies in the way these assemblies respond to elastic buckling (or structural bucking) loads below and beyond critical buckling load yield points.

As is known in structural mechanics art, “elastic buckling” is a phenomenon that occurs when a slender structural component, such as a column or beam, yields under compressive loads, leading to sudden and catastrophic deformations. Elastic buckling occurring in fiberglass composite structures that are typically made of reinforcing fibers (e.g., glass fibers) embedded in polymer matrices (e.g., epoxy resin) is one of the design considerations for construction of robust wind turbine blades and their trailing edge assemblies.

In general, composite structures may utilize a combination of materials, typically fibers and a matrix, to create flexible laminates. The fibers, often made of materials like carbon or glass, provide strength, while the matrix, such as epoxy resin, allows flexibility. In practice, composite materials with varying properties may be employed to achieve the desired flexibility and strength. By carefully arranging and orienting the constituent materials, the composite structures may be enabled to endure repeated movements without compromising their structural integrity. This way, the composite structures are rendered adaptable for applications that require both strength and flexibility such as in trailing edges of wind turbine blades, aircraft wings or in similar other mechanical structures.

Composite structures may exhibit elastic behavior up to a characteristic point, where stress is directly proportional to strain. Further, when fiberglass or such other composite structures are subjected to compressive load, they undergo elastic deformation until they reach critical buckling load yield points. Beyond this critical buckling load yield points, the structures become susceptible to buckling associated with a sudden increase in their lateral deflection.

In a designed configuration, when a composite structure includes two similar but different composite layers (with different fiber architectures and associated elastic yield properties, for instance) coupled together in an integrated or singular homogenous configuration and the composite structure is loaded with a compressive force, the structure may typically resist yielding until a critical yield point load is reached. Beyond the critical yield point load, the composite layer with the higher elastic yield properties is likely to yield first, defining a preconditioned direction of deformation for the integrated composite structure.

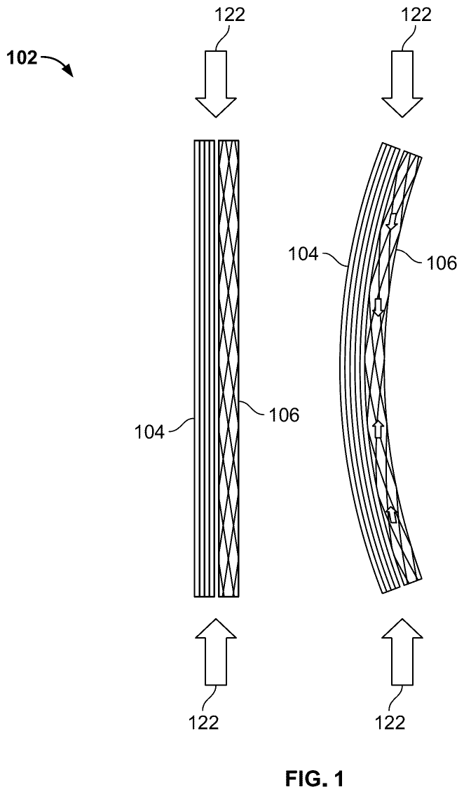

FIG. 1 is an illustrative view of a multi-layer composite body (also referred to as “composite structure”) 102, as disclosed herein. The composite structure 102 may include a first composite layer 104 and a second composite layer 106 that are mechanically coupled with each other. The first composite layer 104 and the second composite layer 106 may extend in a continuous manner with respect to each other and thereby may form the multi-layer composite structure 102 as a substantially two-dimensional, homogenous structure, also referred to as a “laminate”.

The first composite layer 104 may have an associated first elasticity parameter and the second composite layer 106 may have an associated second elasticity parameter. The second elasticity parameter may be different from the first elasticity parameter. The first elasticity parameter may be a modulus of elasticity of the first composite layer 104, as is commonly applicable under externally applied stretching forces, or a buckling coefficient of the first composite layer 104, as applicable under externally applied compressive forces. In a similar manner, the second elasticity parameter may be a modulus of elasticity of the second composite layer 106, under externally applied stretching forces, or a buckling coefficient of the second composite layer 106 under externally applied compressive forces.

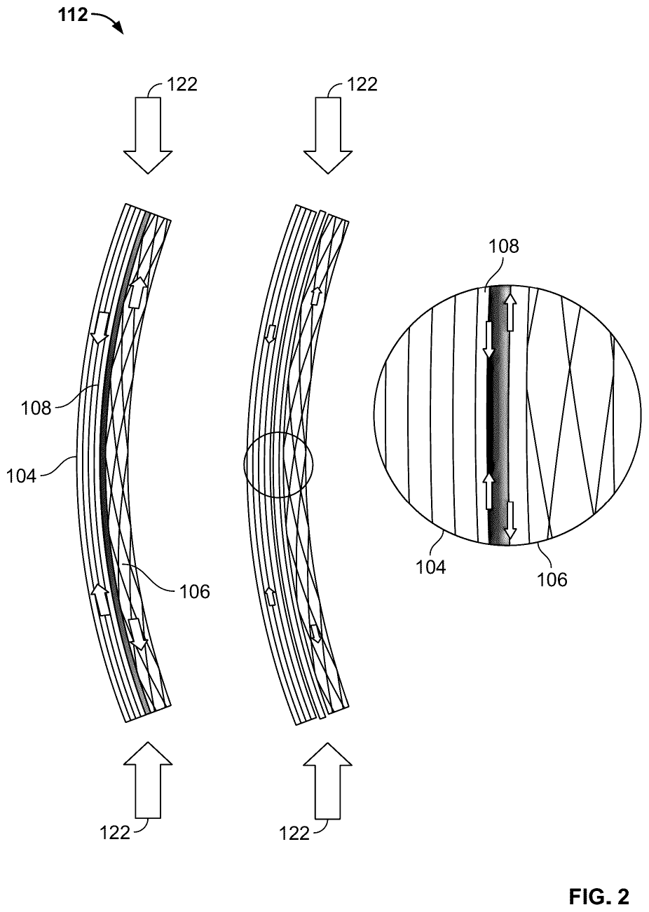

FIG. 2 is an illustrative view of an alternative embodiment 112 of the composite structure 102 of FIG. 1. Referring to FIG. 2, an adhesive layer 108 (such as thermoplastic polyurethane or TPU) may be inserted between and mechanically coupled with the first composite layer 104 and the second composite layer 106. The adhesive layer 108 may typically enhance the mechanical bonding, reduce the shear moment between the first composite layer 104 and the second composite layer 106 and prolong any degradation of the two layers by absorbing and deforming the TPU mass between the two layers.

Referring to FIG. 1 and FIG. 2, the first composite layer 104 and the second composite layer 106 may typically respond to a common external mechanical force 122, such as a stretching forces or a compressive force (or buckling force), in different manners owing to the fact that the second elasticity parameter may be different from the first elasticity parameter.

As is commonly known in elastic deformation art, the first composite layer 104 and the second composite layer 106 may continue to remain in their respective undeformed initial states when the common external mechanical force 122 increases from an initial no-load condition until respective predetermined yield points are reached. The yield point for the first composite layer 104 may be predetermined and/or designed and/or controlled to be different from the yield point for the second composite layer 106.

Referring back to FIG. 1 and FIG. 2, with further increase in the common external mechanical force 122 beyond the respective predetermined yield points, the first composite layer 104 and the second composite layer 106 may deform in accordance with Young's law of stress and strain (also known as “Young's law of elasticity”) and/or further, in accordance with an equivalent law of elastic deformation under buckling load. Specifically, the first composite layer 104 and the second composite layer 106 may deform linearly when the common external mechanical force 122 increases beyond the respective predetermined yield points. Further, the first composite layer 104 and the second composite layer 106 may regain their respective initial undeformed states when the common external mechanical force 122 is withdrawn or it ceases to exist.

The present disclosure provides a way to differentially configure the two layers such that when one layer is stretched, the other may be compressed or vice versa. As a result, the singular laminate (102 of FIG. 1 or 112 of FIG. 2), as a homogenous composite structure with an unbalanced fiber architecture, performs like a spring under external mechanical forces. Once deflection occurs under a buckling load or a stretching load, the composite structure (102 of FIG. 1 or 112 of FIG. 2) yields continuously at or around that same load. When the buckling load decreases below the critical yield point, the laminate returns to its original flat, pre-buckle state. The direction of the bend (or buckle) and the load may be controlled by choosing a number of design factors such as the materials of the two composite layers, their thickness and the architecture of the fibers. For example, the fiber(s) in the first composite layer 104 and/or the second composite layer 106 may be unidirectional fibers in an instance. In an instance, one of the composite layers may have unidirectional fibers and the other composite layer may have biaxial fibers. Further, the biaxial fibers may be stitched, as a non-limiting example, in a 45/−45 weave or any other variable and customizable orientation.

When employed in the trailing edge of a wind turbine blade or in the wings of an aircraft, the composite structure may perform like and have the effect of a passive load controlling and shape restoring mechanism. Further, when the load is withdrawn or ceased the passive load controlling and shape restoring mechanism, i.e., the composite structure (102 of FIG. 1 or 112 of FIG. 2) may bring a deformed trailing edge back to its original undeformed state.

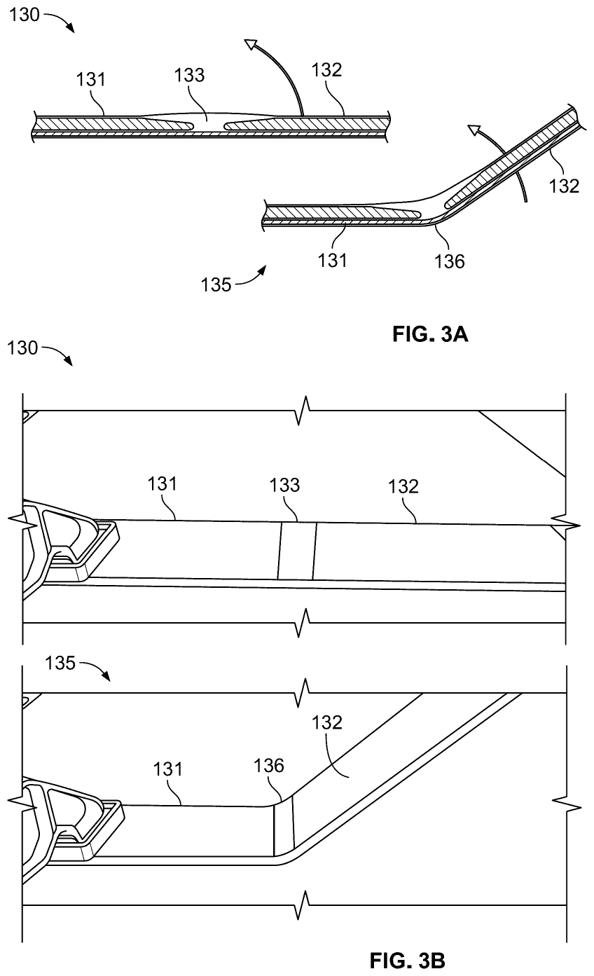

FIG. 3A is an illustrative side view of a composite structure 130 (102 of FIG. 1 or 112 of FIG. 2) under no-load condition, i.e., when there is no common external mechanical force 122 (of FIG. 1 and FIG. 2). FIG. 3A further includes an illustrative side view 135 of the composite structure (also referred to as “composite hinge”) 130 (102 of FIG. 1 or 112 of FIG. 2) under load condition, i.e., when the common external mechanical force 122 (of FIG. 1 and FIG. 2) is acting. FIG. 3B is an illustrative perspective view of the composite structure 130 under no-load condition, i.e., when there is no common external mechanical force 122 (of FIG. 1 and FIG. 2). FIG. 3B further includes an illustrative perspective view 135 of the composite structure (or composite hinge) 130 under load condition, i.e., when the common external mechanical force 122 (of FIG. 1 and FIG. 2) is acting.

Referring to FIGS. 3A and 3B, the first composite layer (104 of FIG. 1 and FIG. 2) includes two transverse parts 131 and 132 joined by a flexible folding zone 133. The two transverse parts 131 and 132 and the folding zone 133 form a reversibly foldable and substantially two-dimensional homogenous composite hinge structure. As is commonly known in elastic deformation art, the first composite layer 104, the two transverse parts 131 and 132, the folding zone 133, and the second composite layer 106 remain in respective undeformed or flat states when the common external mechanical force 122 increases from an initial no-load condition until respective predetermined yield points are reached. The yield point for the first composite layer 104 may be designed and controlled to be different from the predetermined yield point for the second composite layer 106.

Under a further increase in the common external mechanical force (122 of FIG. 1 and FIG. 2) beyond the respective predetermined yield points, the two transverse parts 131 and 132 of the first composite layer (104 of FIG. 1 and FIG. 2) and the second composite layer (106 of FIG. 1 and FIG. 2) may deform in accordance with Young's law of elasticity and/or further, in accordance with equivalent law of elastic deformation under buckling load. Specifically, the two transverse parts 131 and 132 of the first composite layer (104 of FIG. 1 and FIG. 2) and the second composite layer (106 of FIG. 1 and FIG. 2) may deform linearly when the common external mechanical force 122 increases beyond the respective predetermined yield points and bend about the folding zone 133, forming the reversible folded composite hinge structure (or composite hinge) 135.

Thus, the composite hinge structure 130 (in flat state) or 135 (in folded state) of FIGS. 3A and 3B may utilize a combination of materials, typically composite fibers and a matrix, to create a flexible joint. The composite materials may be designed to have varying properties to achieve desired flexibility and strength. As an example, the composite fibers may be made of materials such as carbon or glass to provide strength, while the matrix may be made of materials such as epoxy resin to provide flexibility. By carefully arranging and orienting the composite fibers and the matrix, the composite hinge structure 130 (in flat state) or 135 (in folded state) may be enabled to endure repeated movement without compromising its structural integrity, thereby making it well-suited for applications where both strength and flexibility are essential, such as in trailing edges of wind turbine blades, aircraft wings or such other mechanical structures.

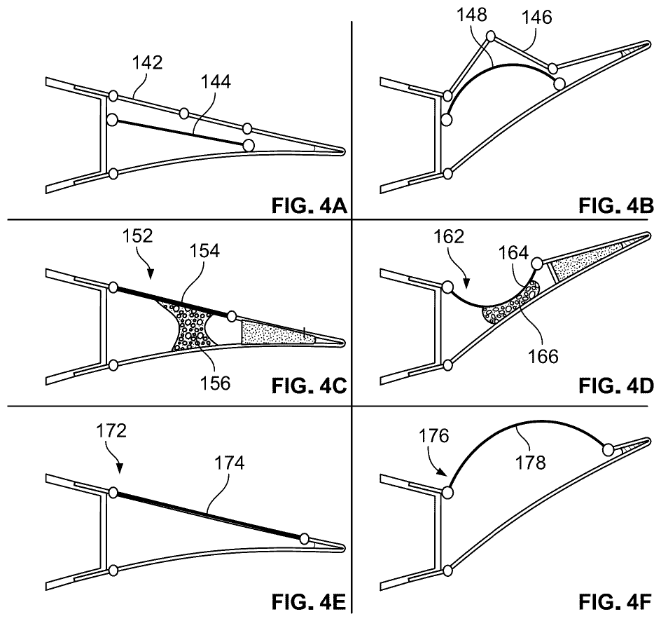

FIG. 4A an illustrative view of a trailing edge 142 of a wind turbine blade under normal or no-load condition. The trailing edge 142 includes a composite structure 144 (102 of FIG. 1 or 112 of FIG. 2) installed inside.

FIG. 4B is an illustrative view of the trailing edge of FIG. 4A under external mechanical force 122 (of FIG. 1 and FIG. 2) such as gust wind or the like. Referring to FIG. 4B, the trailing edge 142 of FIG. 4A may deform to an altered and deformed state 146 with the composite structure 144 deforming to its altered and deformed state 148. In this altered and deformed state, the composite structure 148 may perform like a passive spring waiting to restore to its original shape once the external mechanical force 122 is withdrawn or absent and thereby may bring the deformed trailing edge 146 back to its undeformed state 142 of FIG. 4A.

FIG. 4C an illustrative view of a trailing edge 152 of a wind turbine blade under normal or no-load condition. The trailing edge 152 includes a composite structure 154 (102 of FIG. 1 or 112 of FIG. 2) installed inside and a load dampening structure 156 made of foam or a similar pliable material. The load dampening structure 156 may be internally coupled with the trailing edge 152 and the composite structure 154 and may provide dampening support by reversibly compressing and deforming under an external mechanical load.

FIG. 4D is an illustrative view of the trailing edge of FIG. 4C under external mechanical force 122 (of FIG. 1 and FIG. 2) such as gust wind or the like. Referring to FIG. 4D, the trailing edge 152 of FIG. 4C may deform to an altered and deformed state 162 with the composite structure 154 deforming to its altered and deformed state 164 and the load dampening structure 156 deforming to its altered and deformed state 166. In their altered and deformed states, the composite structure 164 and the load dampening structure 166 may perform like passive springs and dampeners respectively, waiting to restore to their original shapes once the external mechanical force 122 is withdrawn or absent and thereby may bring the deformed trailing edge 162 back to its undeformed state 152 of FIG. 4C.

FIG. 4E an illustrative view of a trailing edge 172 of a wind turbine blade under normal or no-load condition. The trailing edge 172 includes a composite structure 174 (102 of FIG. 1 or 112 of FIG. 2) installed as one of the outer structural members.

FIG. 4F is an illustrative view of the trailing edge of FIG. 4E under external mechanical force 122 (of FIG. 1 and FIG. 2) such as gust wind or the like. Referring to FIG. 4F, the trailing edge 172 of FIG. 4E may deform to an altered and deformed state 176 with the composite structure 174 (installed as an outer structural member) deforming to its altered and deformed state 178. In this altered and deformed state, the composite structure 178 acts like a passive spring waiting to restore to its original shape once the external mechanical force 122 is withdrawn or absent and thereby bring the deformed trailing edge 176 back to its undeformed state 172 of FIG. 4E.

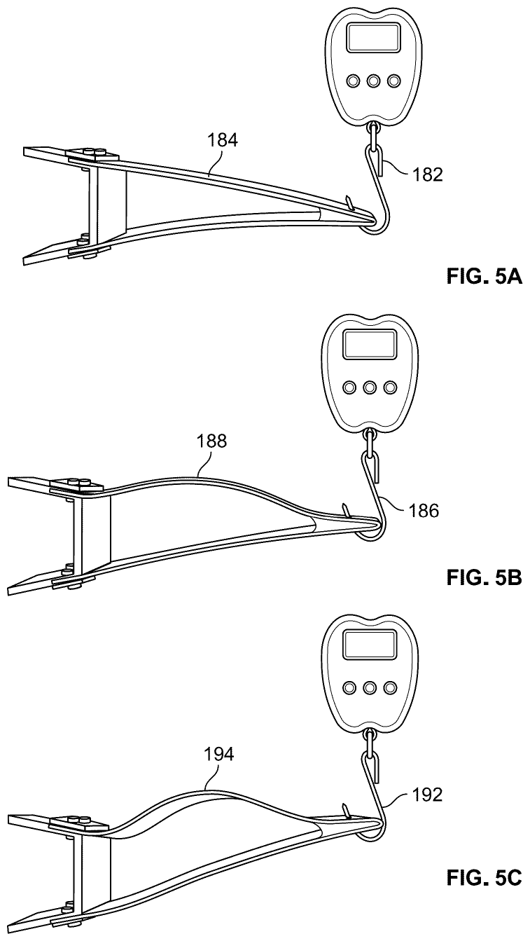

FIG. 5A an illustrative view of a trailing edge (such as 172 of FIG. 4E) of a wind turbine blade under normal or no-external-load condition as represented by an initial loading force (zero, “0”) 182. The trailing edge 172 of FIG. 5A includes a composite structure 184 (102 of FIG. 1 or 112 of FIG. 2) installed as one of the outer structural members.

FIG. 5B is an illustrative view of the trailing edge (such as 172 of FIG. 4E) of FIG. 5A under external mechanical force 186 such as gust wind or the like. Referring to FIG. 5B, the trailing edge 172 of FIG. 5A may deform to an altered and deformed state (such as 176 of FIG. 4F) with the composite structure 182 (installed as an outer structural member) deforming to its altered and deformed state 188. In this altered and deformed state, the composite structure 188 may perform like a passive spring waiting to restore to its original shape 184 once the external mechanical force 186 is withdrawn or absent and thereby may bring the deformed trailing edge (such as 176 of FIG. 4F) back to its undeformed state (such as 172 of FIG. 4E).

FIG. 5C is an illustrative view of the trailing edge of FIG. 5A and FIG. 5B, when the external mechanical force 192 such as gust wind or the like is further increased. Referring to FIG. 5C, the trailing edge 172 of FIG. 5A may deform further to an altered and deformed state (such as 176 of FIG. 4F) with the composite structure 182 (installed as an outer structural member) deforming further, in a linear relationship with the external mechanical force 192, to its further altered and deformed state 194. In this altered and deformed state, the composite structure 194 may perform like a passive spring waiting to restore to its original shape 184 once the external mechanical force 186 is withdrawn or absent and thereby may bring the deformed trailing edge (such as 176 of FIG. 4F) back to its undeformed state (such as 172 of FIG. 4E).

In recent years, there has been a significant focus on mitigating the adverse effects of aerodynamic drag, noise, and fatigue in wind turbine blades. The trailing edge systems and methods of this disclosure aim to construct solid-state passive trailing edges that structurally resist a linear load until a controlled yield point is reached. At this point, a controlled deflection may occur until the buckling load is reduced back to a sub-deflection level, when the laminate returns to a flat baseline shape. This is achieved by constructing a singular and homogenous composite structure that integrates two or more composite layers having diverse fiber architectures, resin matrices, mixed materials, plastics and the like.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A multi-layer composite body comprising:
a first composite layer having a first elasticity parameter; and
a second composite layer mechanically coupled with the first composite layer, the second composite layer having a second elasticity parameter different from the first elasticity parameter,
wherein the first composite layer comprises at least two transverse parts joined by a flexible folding zone, the at least two transverse parts and the folding zone forming a reversibly foldable and substantially two-dimensional homogenous structure.

2. The multi-layer composite body of claim 1, wherein the first elasticity parameter comprises a first modulus of elasticity and a first buckling coefficient and the second elasticity parameter comprises a second modulus of elasticity and a second buckling coefficient.

3. The multi-layer composite body of claim 2, wherein the first composite layer and the second composite layer respond to a common external mechanical force in a different manner.

4. The multi-layer composite body of claim 3, wherein the common external mechanical force comprises a stretching force and a bucking load.

5. The multi-layer composite body of claim 4, wherein the first composite layer and the second composite layer remain in respective undeformed states with a first increase in the common external mechanical force until respective predetermined yield points are reached, wherein a first predetermined yield point for the first composite layer is different from a second predetermined yield point for the second composite layer.

6. The multi-layer composite body of claim 5, wherein the first composite layer and the second composite layer deform with a second increase in the common external mechanical force beyond the respective predetermined yield points.

7. The multi-layer composite body of claim 6, wherein the first composite layer and the second composite layer deform linearly under the second increase in the common external mechanical force beyond the respective predetermined yield points.

8. The multi-layer composite body of claim 7, wherein the at least two transverse parts of the first composite layer and the second composite layer bend about the folding zone under the second increase in the common external mechanical force beyond the respective predetermined yield points, forming a reversible folded structure.

9. The multi-layer composite body of claim 7, wherein the first composite layer and the second composite layer regain respective undeformed states when the common external mechanical force is withdrawn.

10. The multi-layer composite body of claim 1 further comprising an adhesive layer inserted between and mechanically coupled with the first composite layer and the second composite layer, the adhesive layer configured to enhance a mechanical bonding, and reduce a shear moment between the first composite layer and the second composite layer.

11. The multi-layer composite body of claim 1, wherein the at least two transverse parts comprise two transverse parts.

12. A multi-layer composite body comprising:
a first composite layer having a first elasticity parameter; and
a second composite layer mechanically coupled with the first composite layer, the second composite layer having a second elasticity parameter different from the first elasticity parameter,
wherein the first composite layer comprises at least two transverse parts joined by a flexible folding zone, the at least two transverse parts and the folding zone forming a reversibly foldable and substantially two-dimensional homogenous structure,
wherein the first elasticity parameter comprises a first modulus of elasticity and a first buckling coefficient and the second elasticity parameter comprises a second modulus of elasticity and a second buckling coefficient, and
wherein the first composite layer and the second composite layer respond to a common external mechanical force in a different manner.

13. The multi-layer composite body of claim 12, wherein the at least two transverse parts comprise two transverse parts.

14. A wind turbine blade comprising the multi-layer composite body of claim 1.

15. A wind turbine comprising one or more turbine blades, the one or more wind turbine blades comprising the multi-layer composite body of claim 1.
